(19) United States
(12) Patent Application Publication
(10) Pub. No.: US 2010/0146451 A1
(43) Pub. Date: Jun. 10, 2010

(54) HANDHELD TERMINAL CAPABLE OF SUPPORTING MENU SELECTION USING DRAGGING ON TOUCH SCREEN AND METHOD OF CONTROLLING THE SAME

(75) Inventors: Cho Jun-Dong, Seongnam-si (KR); Kim Jae Gon, Goyang-si (KR); Hwang Jin Woo, Namyangju-si (KR); Jin Duk Yang, Seoul (KR)

Correspondence Address: LEXYOUME IP GROUP, LLC, 5180 PARKSTONE DRIVE, SUITE 175, CHANTILLY, VA, 20151, US

(73) Assignee: SUNGKYUNKWAN UNIVERSITY FOUNDATION FOR CORPORATE COLLABORATION, Suwon-si (KR)

(21) Appl. No.: 12/363,861

(22) Filed: Feb. 2, 2009

(30) Foreign Application Priority Data
Dec. 9, 2008 (KR) 10-2008-0124619

(51) Int. Cl. G06F 3/048

(52) U.S. Cl. 715/841

(57) ABSTRACT

The present invention relates to a handheld terminal capable of supporting menu selection using dragging on a touch screen and a method of controlling the handheld terminal. When one of first level menu items displayed on a touch screen is touched, one or more second level menus belonging to the touched first level menu item are displayed. When a drag to one of the second level menu items is performed, a plurality of third level menu items belonging to a menu item corresponding to a location at which the drag was performed is displayed. When a release, ending the touch, is performed, a menu item corresponding to a location at which the release was performed is selected. Therefore, a user can select his or her menu item using a single touch and drag operation.

### BACKGROUND OF THE INVENTION

1. Field of the Invention

The present invention relates to a handheld terminal capable of supporting menu selection using dragging on a touch screen and a method of controlling the handheld terminal.

2. Description of the Related Art

A touch screen is a kind of display interface which is provided with a touch-sensitive transparent panel covering a screen and which is capable of recognizing a touch input on a screen. Typically, a touch screen display includes a processing unit which is operated under the control of a program. When a touch screen is used to input a command into an application currently being executed on a computer or on various types of mobile terminals, a user selects the objects of a Graphic User Interface (GUI) displayed on a display screen by directly touching the objects with a stylus or a finger.

FIG. 1 is a diagram showing a tree-structured menu provided by a typical handheld terminal.

As shown in FIG. 1, a handheld terminal typically uses a tree-structured menu to allow a user to more conveniently select menu items.

Such a tree-structured menu includes a plurality of levels. A user repeats a procedure for primarily selecting a highest level menu item and secondarily selecting a lower level menu item belonging to the selected highest level menu item, thus finally selecting his or her desired menu item.

For example, in FIG. 1, in order to select an “email” menu item provided by a handheld terminal, the user must select a “call” menu item, which is the highest level menu item. When the “call” menu item is selected, the handheld terminal outputs lower level menu items, such as “communication company service”, “making call”, “phone book”, “call history”, “video call setting” and “messages”.

When the user secondarily selects the “messages” menu item, the handheld terminal outputs menu items, such as “send message”, “received message folder”, “sent message folder”, “email”, “send picture”, “message folder”, “attached file folder”, “spam messages”, and “message settings”, which belong to the “messages” menu item.

The user can execute his or her desired “email” application by selecting the “email” menu item from among the output menu items.

In the prior art, in order to use such a tree-structured menu, predetermined buttons, such as the four direction keys on a handheld terminal, were used. However, recently, in order to select a desired menu item from the tree-structured menu shown in FIG. 1, a method using a touch screen or the like has been used.

FIGS. 2A to 2C are diagrams showing a method of selecting a tree-structured menu using a touch screen in a conventional handheld terminal.

In detail, FIGS. 2A to 2C illustrate examples in which a touch screen is used in order for a user to sequentially select menu items “call” >“phone book” >“search contacts”.

As shown in FIG. 2A, a user touches and releases a “call” menu item on the screen with a stylus or a finger. Through such a touch and release operation, the handheld terminal senses the selection of the “call” menu item, and outputs lower level menu items belonging to the “call” menu item.

As shown in FIG. 2B, when the lower level menu items belonging to the “call” menu item are displayed, the user touches and releases a “phone book” menu item. The handheld terminal displays lower level menu items belonging to the “phone book” menu item in a predetermined region.

As a result, the user subsequently touches and releases a “search contacts” menu item belonging to the lower level menu items of the “phone book” menu item, thus selecting his or her desired menu item.

According to the conventional tree-structured menu selection method using a touch screen, as described above with reference to FIGS. 2A to 2C, there is an inconvenience in that the user must touch the touch screen of a handheld terminal more than several times to select a desired menu item. Further, there is a problem in that, as the number of touches increases to select a menu item, the lifespan of a touch screen is shortened. Furthermore, there is a problem in that, since buttons must be pressed or the screen must be touched several times, a lot of time is required in order for the user to select a desired menu item.

### SUMMARY OF THE INVENTION

Accordingly, the present invention has been made keeping in mind the above problems occurring in the prior art, and an object of the present invention is to provide a handheld terminal and a method of controlling the handheld terminal which employ a draw-drag pop-up user interface that is capable of selecting all menu items on a tree-structured menu using a single touch and drag operation.

In accordance with an aspect of the present invention to accomplish the above object, there is provided a method of controlling a handheld terminal including a touch screen, comprising, when one of a plurality of first level menu items displayed on the touch screen is touched, displaying one or more second level menu items belonging to the touched first level menu item; and when a drag from the touched first level menu item to one of the second level menu items is performed, displaying one or more third level menu items belonging to the second level menu item corresponding to a location at which the drag was terminated.

Preferably, the method may further comprise, when a release, ending a touch, is sensed, executing a command or an application corresponding to a menu item preset at a location at which the release was performed. In this case, the method may further comprise, when a menu item corresponding to the location at which the release was performed is not present, displaying an error message. Further, the method may further comprise, when a menu item corresponding to a location at which the drag was terminated is not present, displaying an error message. Further, the method may further comprise waiting for subsequent input from a user after displaying the error message.

Meanwhile, the method may further comprise, when a menu item corresponding to a location at which the touch or drag was terminated is a multimedia file icon, displaying information about the multimedia file.

Preferably, the method may further comprise, when a drag to a region in which the multimedia file information is displayed is performed, displaying a menu item for playing the multimedia file.

Preferably, the displaying one or more third level menu items belonging to the location at which the drag was terminated may be performed to additionally display a higher level menu item of the second menu item.

In accordance with another aspect of the present invention to accomplish the above object, there is provided a method of providing a user interface using a touch screen, comprising, when one of a plurality of menu items displayed on the touch screen is touched, displaying information or a menu item corresponding to a location at which a touch was made; when a drag to the displayed information or menu item is performed, displaying information or a menu item corresponding to a location at which the drag was terminated; and when a release, ending a touch, is performed, executing a command corresponding to a location at which the release was performed.

Preferably, the method may further comprise, when a command corresponding to the location at which the release was performed is not present or when information or a menu item corresponding to the location at which the drag was terminated is not present, displaying an error message. The method may further comprise waiting for subsequent input from a user after displaying the error message.

Preferably, the method may further comprise, when information or a menu item corresponding to a location at which the touch or the drag was terminated is a multimedia file icon, displaying information about the multimedia file.

In accordance with a further aspect of the present invention to accomplish the above object, there is provided a handheld terminal, comprising a touch screen including a display device and a touch sensing device for sensing touch input; and a control unit configured such that, when one of a plurality of first level menu items displayed on the touch screen is touched, the control unit displays one or more second level menu items belonging to the touched first level menu item, and such that, when a drag from the touched first level menu item to one of the second level menu items is performed, the control unit displays one or more third level menu items belonging to the second level menu item corresponding to a location at which the drag was terminated.

Preferably, when the touch sensing device senses a release ending the touch, the control unit may execute a command or an application corresponding to a location at which the release was performed. Further, the control unit may display an error message when a menu item corresponding to the location at which the release was performed is not present.

Preferably, the control unit may display an error message when a menu item corresponding to the location at which the drag was terminated is not present. Further, the control unit may wait for subsequent input from a user after displaying the error message.

Preferably, the control unit may display information about a multimedia file when the touched or dragged menu item is a multimedia file icon. Preferably, when a drag to a region in which the multimedia file information is displayed is performed, the control unit may display a menu item for playing the multimedia file.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram showing a tree-structured menu provided by a typical handheld terminal;

FIGS. 2A to 2C are diagrams showing a method of selecting a menu item from a tree-structured menu using a touch screen in a conventional handheld terminal;

FIG. 3 is a block diagram showing the construction of a handheld terminal according to an embodiment of the present invention;

FIG. 4 is a flowchart showing a method of controlling a handheld terminal based on a touch event according to another embodiment of the present invention;

FIG. 5 is a flowchart showing a method of controlling a handheld terminal based on a release event according to a further embodiment of the present invention;

FIG. 6 is a flowchart showing a method of controlling a handheld terminal based on a drag event according to yet another embodiment of the present invention;

FIGS. 7A to 7E are diagrams showing an embodiment of a first operation of the handheld terminal of FIG. 3; and

FIGS. 8A to 8F are diagrams showing an embodiment of a second operation of the handheld terminal of FIG. 3.

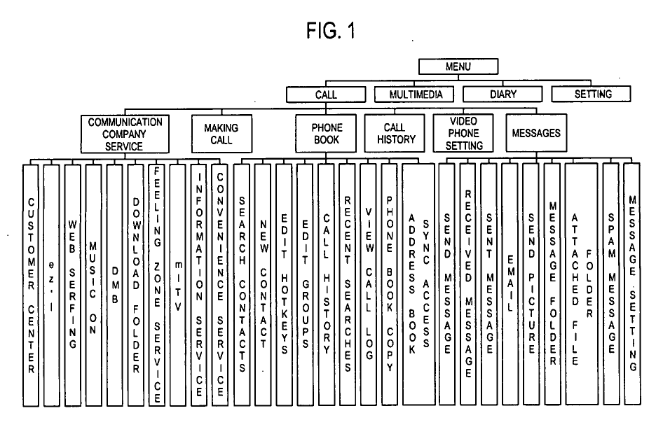

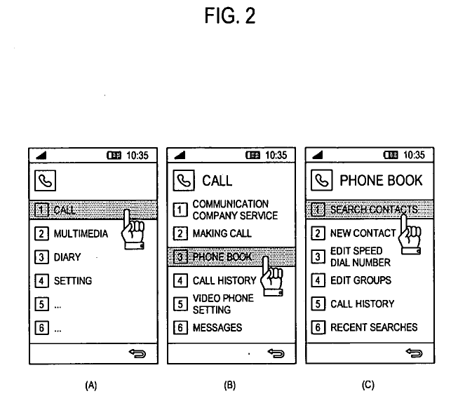

### DESCRIPTION OF THE PREFERRED EMBODIMENTS

Reference now should be made to the drawings, in which the same reference numerals are used throughout the different drawings to designate the same or similar components.

Hereinafter, embodiments of a handheld terminal capable of supporting menu selection using dragging on a touch screen and a method of controlling the handheld terminal according to the present invention will be described in detail with reference to the attached drawings.

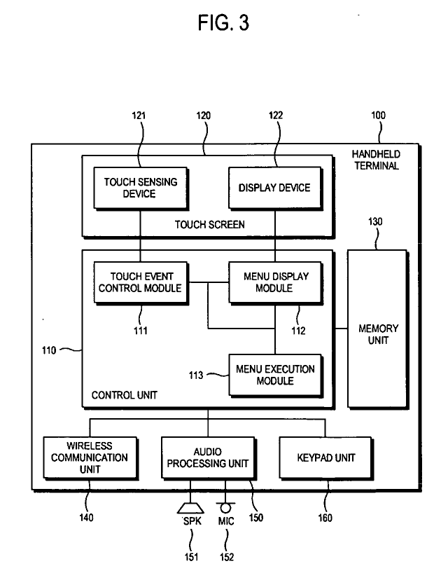

FIG. 3 is a block diagram showing the construction of a handheld terminal according to an embodiment of the present invention.

As shown in FIG. 3, a handheld terminal 100 includes a control unit 110, a touch screen 120, a memory unit 130, a wireless communication unit 140, an audio processing unit 150, and a keypad unit 160.

The touch screen 120 may include a touch sensing device 121 and a display device 122.

Further, the touch sensing device 121 of the touch screen 120 not only can sense the touch of a user, but also can recognize the location and magnitude of a touch occurring on the surface of a touch pad. The touch sensing device 121 senses the generation of various touch screen events through various methods, such as the sensing of capacitance, resistance, surface acoustic waves, pressure or light.

The term “touch screen event” means an event in which the user makes a certain touch or performs a drag on the touch screen. For example, touch screen events may include a touch event enabling a touch to be made, a drag event enabling a cursor on the touch screen to move from a certain point to another point while the user's finger or stylus remains in contact with the touch screen, and a release event ending a touch.

The touch sensing device 121 transmits the type of generated event and information about the event (for example, information about a location at which a touch was made, the magnitude of the touch, the start and end locations of a drag, and a location at which the touch was released) to the touch event control module 111 of the control unit 110.

The display device 122 of the touch screen 120 generally outputs a Graphic User Interface (GUI) or the like to interface between the user and an operating system or an application currently being executed on the operating system. For example, the display device 122 may output windows, fields, dialog boxes, menu items, icons, a cursor, a scroll bar, etc.

Meanwhile, the control unit 110 takes charge of the entire control of the handheld terminal 100. The control unit 110 can perform various types of wireless communication functions of the handheld terminal 10 in association with the wireless communication unit 140. Further, the control unit 110 may output voice or sound through a speaker 151 or receive voice or sound through a microphone 152 in association with the audio processing unit 150. Further, the control unit 110 may receive key input from the keypad unit 160 and may execute a command corresponding to the key input from the user, as in the case of a conventional handheld terminal.

In relation to the present invention, the control unit 110 processes a command corresponding to the user's command input on the touch screen 120. For this operation, the control unit 110 may include a touch event control module 111, a menu display module 112, and a menu execution module 113.

The touch event control module 111 receives information related to a touch event from the touch sensing device 121 of the touch screen 120. Thereafter, the touch event control module 111 determines and controls an operation corresponding to the touch event.

In detail, when a displayed first menu item is touched, the touch event control module 111 performs control so that the menu display module 112 displays lower level menu items of the first menu item. In this case, it is preferable that the lower level menu items be displayed close to the first menu item so that the user can easily identify the lower level menu items.

The user can perform a drag to one of the displayed lower level menu items while touching the touch screen to select the first menu item. The touch event control module 111, having received such a drag event, can perform control such that the menu display module 112 displays the lower level menu items of a menu item corresponding to the location at which the drag operation was terminated.

Finally, when a release event ending the touch at an arbitrary location occurs, the touch event control module 111 can perform control such that the menu execution module 113 executes a menu item corresponding to a location at which the release was performed.

The menu display module 112 performs an operation of displaying a relevant menu item on the display device 122 of the touch screen 120 under the control of the touch event control module 111.

Further, the menu execution module 113 executes a relevant menu item under the control of the touch event control module 111. For example, when the user releases the touch at a current touched menu item “create message”, the touch event control module 111 requests the execution of “create message” from the menu execution module 113, and thus the menu execution module 113 may execute an application corresponding to “create message”.

At this time, the menu execution module 113 can execute applications or instructions stored in the memory unit 130.

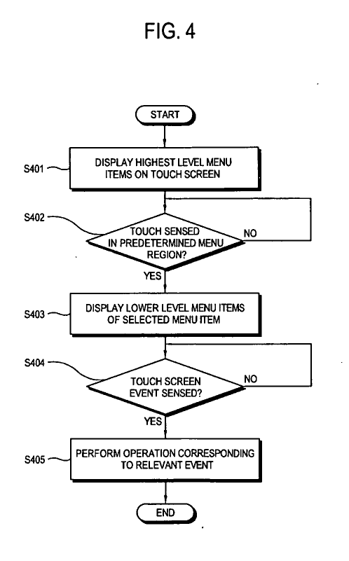

FIG. 4 is a flowchart showing a method of controlling a handheld terminal based on a touch event according to another embodiment of the present invention.

First, the handheld terminal 100 displays the highest level menu items on the display device 122 of the touch screen 120 at step S401. In this case, the highest level menu items are preferably displayed in the form of a plurality of icons or images. However, it is also possible to display the highest level menu items in other forms.

The handheld terminal 100 according to the present invention determines whether a touch input has been made by the user in a predetermined region at step S402. When the highest level menu items are displayed in the form of a plurality of icons, the predetermined region may preferably match a region in which respective icons are displayed.

The handheld terminal 100 may display menu items corresponding to the location at which the touch was made at step S403. At this time, the handheld terminal 100 is intended to display lower level menu items belonging to the highest level menu item corresponding to the location at which the touch was made. Similar to step S401, in order for the user to conveniently identify lower level menu items, it is preferable that the lower level menu items also be displayed in the form of a plurality of icons at step S403.

The handheld terminal 100 determines whether a subsequent touch screen event has been input in the state in which the touch is continued at step S404.

If it is determined that any touch screen event is not sensed, the handheld terminal 100 continuously waits for a touch screen event to be input. At this time, possible touch screen events may include a drag event enabling a cursor to be dragged to a lower level menu item and a release event ending a touch.

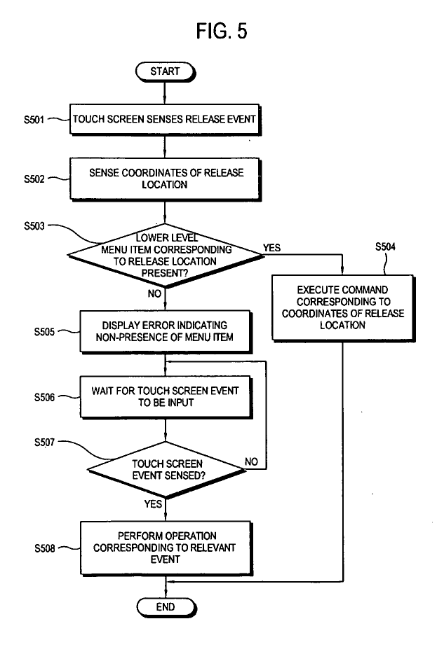

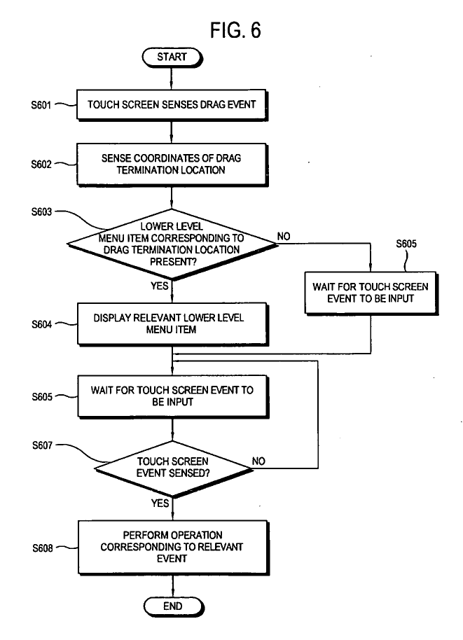

If it is determined that a touch screen event is sensed, the handheld terminal 100 performs an operation corresponding to the sensed touch screen event at step S405. A release event ending a touch and a drag event enabling a cursor to be dragged to a lower level menu item will be described below with reference to FIGS. 5 and 6, respectively.

FIG. 5 is a flowchart showing a method of controlling a handheld terminal based on a release event according to a further embodiment of the present invention.

The touch sensing device 121 of the touch screen 120 senses a release event at step S501. Accordingly, the control unit 110 of the handheld terminal 100 receives the coordinates of the location at which the release was performed from the touch sensing device 121 at step S502.

The handheld terminal 100 determines whether a lower level menu item corresponding to the location at which a release, ending a touch, was performed at step S503. If it is determined that the menu item corresponding to the location at which the release was performed is present, the handheld terminal 100 executes a command or an application corresponding to the menu item at step S504.

However, in some cases, a lower level menu item corresponding to the location at which a release, ending a touch, was performed is not present at step S503. That is, the case whether a release was performed in a region in which icons or images corresponding to respective menu items are not displayed may exist.

In this case, the handheld terminal 100 may display an error message indicating that a relevant menu item or command is not present at step S505.

Thereafter, the handheld terminal 100 preferably waits for another touch screen event to be input from the user at step S506. The reason for this is that, if setting is made such that the handheld terminal 100 is returned to the initial state thereof after displaying the error message, it is difficult to recover the place in the menu selection process where the user was at when the user releases the touch by mistake.

The handheld terminal 100 senses again whether a touch screen event has occurred at step S507. When the user performs a touch or a drag on the touch screen 120, the handheld terminal 100 performs control corresponding to the touch or the drag at step S508.

FIG. 6 is a flowchart showing a method of controlling a handheld terminal based on a drag event according to yet another embodiment of the present invention.

The touch sensing device 121 of the touch screen 120 senses the input of a drag event from the user at step S601. In this case, the control unit 110 of the handheld terminal 100 receives the coordinates of the location at which a drag was terminated from the touch sensing device 121 at step S602.

Similarly to step S503, the handheld terminal 100 determines whether a menu item corresponding to a location at which the drag was terminated is present at step S603. If it is determined at step S603 that a menu item corresponding to the termination location of the drag is not present, the handheld terminal 100 displays an error message indicating that a lower level menu item is not present at step S605, and waits for a subsequent touch screen event to be input at step S606.

If it is determined at step S603 that a menu item corresponding to the termination location of the drag is present, the handheld terminal 100 displays lower level menu items belonging to the menu item or information about the menu items at step S604.

In this case, the handheld terminal 100 does not need to display only the lower level menu items belonging to the termination location of the drag at step S604. For example, when a drag is terminated on the icon of the album of a specific singer, information about the album may be displayed. Further, the lower level menu items or information related to the drag termination location are preferably displayed close to the previously displayed menu item.

After the display of the lower level menu items at step S604, the handheld terminal 100 waits for another touch screen event to be input at step S606. When a touch screen event is newly input, the handheld terminal 100 performs an operation corresponding to the event at step S608.

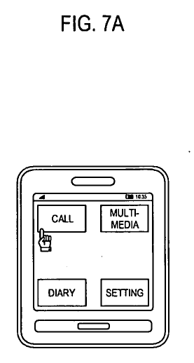

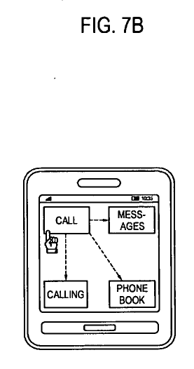

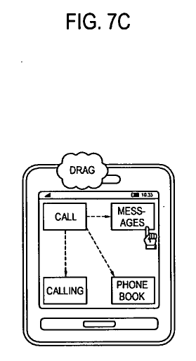

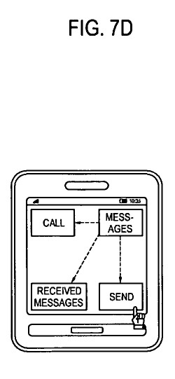

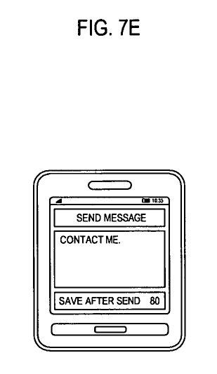

FIGS. 7A to 7E are diagrams showing an embodiment of the first operation of the handheld terminal of FIG. 3.

First, FIG. 7A illustrates the state in which the highest level menu items are displayed, as described above with reference to step S401 of FIG. 4. It can be seen that the highest level menu items, such as “call”, “multimedia”, “diary” and “setting”, are displayed on the display device 122 of the touch screen 120.

FIG. 7B illustrates an image of an operation screen when a touch was made in a predetermined menu region, as described above with reference to step S402 of FIG. 4. In detail, FIG. 7B illustrates the operation of the case where the user touches a “call” menu item from among the highest level menu items.

In this case, the handheld terminal displays lower level menu items belonging to the menu item on which the touch was made, as in the case of step S403. It can be seen in FIG. 7B that menu items such as “messages”, “calling”, and “phone book” are displayed in the corners of the display device.

Thereafter, in order to select the lower level menu items, such as “messages”, “calling” and “phone book”, the user drags the “call” icon to his or her desired lower level menu item with a finger or a stylus in the state in which the “call” icon is being touched. FIG. 7C illustrates the state in which the user performs a drag from the “call” menu item to the “messages” menu item, which is his or her desired menu item, while touching the touch screen on which the “call” menu item is displayed.

FIG. 7D illustrates the display screen of the handheld terminal 100 based on the drag operation of FIG. 7C. As shown in FIG. 7D, the “messages” menu item is displayed in an upper right portion of the screen of the handheld terminal. Meanwhile, the handheld terminal displays “received messages” and “send” menu items, which are lower level menu items of the “messages” menu item, on lower left and lower right portions of the screen, in accordance with step S604. Of course, the locations at which the lower level menu items are displayed can freely change.

Further, it can be seen that, in an upper left portion of FIG. 7D, the “call” menu item, which is the upper menu item of the “messages” menu item, is also displayed. When the “call” menu item, which is the upper menu item of “messages”, is prevented from disappearing, the user can drag the “messages” menu items to the “call” menu item with the finger or stylus, thus returning to the highest level menu item. This allows the user to more easily navigate between respective menu items in a hierarchical menu structure.

In FIG. 7D, the user performs a drag to the “send” menu item, which is one of the lower level menu items of “messages” with the finger or stylus, and performs a release enabling the finger or the stylus to be removed from the “send” menu item displayed on the touch screen 120. In this case, the handheld terminal 100 executes a command or an application corresponding to the location at which the release was performed, that is, the “send” menu item, in accordance with step S503.

FIG. 7E illustrates the results of the command corresponding to the “send” menu item executed by the handheld terminal 100. The handheld terminal 100 executes the application corresponding to the “send” menu item. As a result of the execution of the application, a “send message” menu item, a message field into which the user enters message content desired to be sent, and a select option such as “save after send” which enables a sent message to be saved after being sent, are displayed. Further, the handheld terminal 100 waits for the user to enter content into the message field or input the select option.

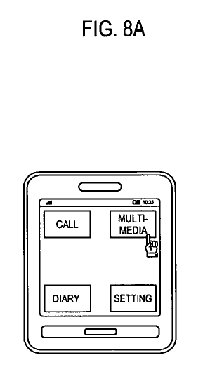

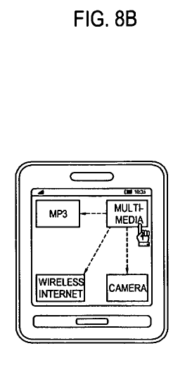

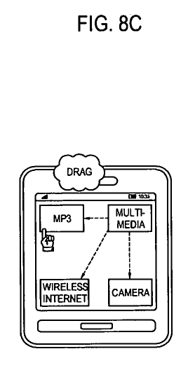

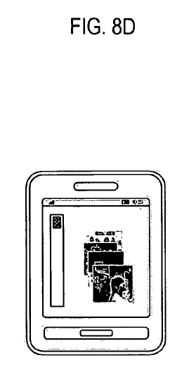

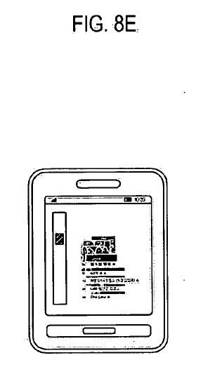

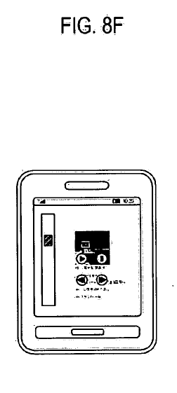

FIGS. 8A to 8F are diagrams showing an embodiment of the second operation of the handheld terminal of FIG. 3.

FIG. 8A illustrates the state in which, similar to FIG. 7A, the handheld terminal 100 displays the highest level menu items such as “call”, “multimedia”, “diary”, and “setting”. Here, the user touches the “multimedia” menu item with a finger or a stylus.

In FIG. 8B, the handheld terminal 100 displays lower level menu items of the “multimedia” menu item according to touch input received from the user. In detail, the handheld terminal 100 outputs “MP3”, “wireless Internet” and “camera” which are the lower level menu items of the “multimedia” menu item.

FIG. 8C illustrates results obtained when the user performs a drag to “MP3” among the lower level menu items belonging to the “multimedia” menu item. When a lower level menu item belonging to the “MP3” menu item is not present, the handheld terminal 100 can immediately execute an application corresponding to “MP3” even if a release event does not occur.

FIG. 8D illustrates a screen on which the handheld terminal executes the application corresponding to the “MP3” menu item. In FIG. 8D, a scroll bar is displayed on a left portion of the screen and the albums of respective singers are displayed on a right portion of the screen.

The user can scroll the albums of respective singers by dragging the left scroll bar. For example, when the user drags the scroll bar downwards, albums which are arranged behind an album arranged on the very front of the screen can be scrolled and arranged on the very front.

In particular, when the user does not remove the finger or the stylus from the touch screen, the handheld terminal 100 can additionally display information about a specific album arranged on the front of the screen.

The album information that can be displayed includes the title and year of publication of each album, information about songs in respective tracks of the album, information about composers, information about copyrighters and information about singers of original songs.

FIG. 8E illustrates the state in which the user drags the scroll bar to the icon or the image of an album arranged on the front of the screen in order for the user to view the displayed album information and select a desired album.

In this case, the handheld terminal 100 displays the lower level menu items of the album selected through the drag operation. It can be seen through FIG. 8E that the handheld terminal 100 displays respective menu items “ [symbol] ” and “□” required to listen to the selected album according to the drag operation of the user.

The user performs a drag to the menu item “ [symbol] ” and releases the menu item “ [symbol] ” so as to listen to the album. The handheld terminal 100, having sensed the release at the menu item “ [symbol] ”, executes an application for playing the album.

As described above, a handheld terminal capable of supporting menu selection using dragging on a touch screen and a method of controlling the handheld terminal according to the present invention are advantageous in that, since the selection or determination of all menu items in a tree-structured menu can be rapidly performed through a single touch and drag operation, a user can rapidly select menu items compared to a conventional method of selecting menu items using a touch screen once the user becomes accustomed to the interface of the present invention.

In addition, the number of touches on a touch screen can be greatly reduced, and thus the number of times that the touch screen is put out of order can be reduced, and the lifespan of the touch screen can be naturally extended.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Therefore, the scope of the present invention should not be limited to the above embodiments and should be defined by the accompanying claims and equivalents thereof.

What is claimed is:

1. A method of controlling a handheld terminal including a touch screen, comprising:
when one of a plurality of first level menu items displayed on the touch screen is touched, displaying one or more second level menu items belonging to the touched first level menu item; and
when a drag from the touched first level menu item to one of the second level menu items is performed, displaying one or more third level menu items belonging to the second level menu item corresponding to a location at which the drag was terminated.

2. The method according to claim 1, further comprising:
when a release, ending a touch, is sensed, executing a command or an application corresponding to a menu item preset at a location at which the release was performed.

3. The method according to claim 2, further comprising:
when a menu item corresponding to the location at which the release was performed is not present, displaying an error message.

4. The method according to claim 1, further comprising:
when a menu item corresponding to a location at which the drag was terminated is not present, displaying an error message.

5. The method according to claim 4, further comprising:
waiting for subsequent input from a user after displaying the error message.

6. The method according to claim 1, further comprising:
when a menu item corresponding to a location at which the touch or drag was terminated is a multimedia file icon, displaying information about the multimedia file.

7. The method according to claim 6, further comprising:
when a drag to a region in which the multimedia file information is displayed is performed, displaying a menu item for playing the multimedia file.

8. The method according to claim 1, wherein the displaying one or more third level menu items belonging to the location at which the drag was terminated is performed to additionally display a higher level menu item of the second menu item.

9. A method of providing a user interface using a touch screen, comprising:
when one of a plurality of menu items displayed on the touch screen is touched, displaying information or a menu item corresponding to a location at which a touch was made;
when a drag to the displayed information or menu item is performed, displaying information or a menu item corresponding to a location at which the drag was terminated; and
when a release, ending a touch, is performed, executing a command corresponding to a location at which the release was performed.

10. The method according to claim 9, further comprising:
when a command corresponding to the location at which the release was performed is not present or when information or a menu item corresponding to the location at which the drag was terminated is not present, displaying an error message.

11. The method according to claim 10, further comprising:
waiting for subsequent input from a user after displaying the error message.

12. The method according to claim 11, further comprising:
when information or a menu item corresponding to a location at which the touch or the drag was terminated is a multimedia file icon, displaying information about the multimedia file.

13. A handheld terminal, comprising:
a touch screen including a display device and a touch sensing device for sensing touch input; and
a control unit configured such that, when one of a plurality of first level menu items displayed on the touch screen is touched, the control unit displays one or more second level menu items belonging to the touched first level menu item, and such that, when a drag from the touched first level menu item to one of the second level menu items is performed, the control unit displays one or more third level menu items belonging to the second level menu item corresponding to a location at which the drag was terminated.

14. The handheld terminal according to claim 13, wherein when the touch sensing device senses a release ending the touch, the control unit executes a command or an application corresponding to a location at which the release was performed.

15. The handheld terminal according to claim 14, wherein the control unit displays an error message when a menu item corresponding to the location at which the release was performed is not present.

16. The handheld terminal according to claim 14, wherein the control unit displays an error message when a menu item corresponding to the location at which the drag was terminated is not present.

17. The handheld terminal according to claim 16, wherein the control unit waits for subsequent input from a user after displaying the error message.

18. The handheld terminal according to claim 13, wherein the control unit displays information about a multimedia file when the touched or dragged menu item is a multimedia file icon.

19. The handheld terminal according to claim 18, wherein when a drag to a region in which the multimedia file information is displayed is performed, the control unit displays a menu item for playing the multimedia file.
